(19) United States
(12) Patent Application Publication
(10) Pub. No.: US 2016/0170717 A1
(43) Pub. Date: Jun. 16, 2016

(54) ASSOCIATION OF PROGRAM CODE AND APPLICATION FEATURES

(71) Applicant: Daniel Zoch, Walldorf (DE)

(72) Inventor: Daniel Zoch, Walldorf (DE)

(21) Appl. No.: 14/566,978

(22) Filed: Dec. 11, 2014

(51) Int. Cl. G06F 9/44; G06F 9/45

(52) U.S. Cl. CPC G06F 8/30; G06F 8/41

(57) ABSTRACT

A system includes determination of a feature of a software application to be removed from the software application, identification of stored data associating an identifier of the feature with first program code, modification of source code of the software application based on the first program code, and compilation of the modified source code to generate a modified software application.

### BACKGROUND

A software application is designed to include a number of features. These features may include core functionality, user interface controls, application programming interfaces, internal and external messaging support, etc. Typically, one or more software developers develops program code which implements the desired features, and the code is compiled to generate the software application.

Software applications are updated regularly, and each new release offers a different mix of features than prior versions. Several different versions of a software application may be offered for various usage scenarios (e.g., home, business, etc.), with each version also providing a unique mix of features. Software developers modify the program code of a software application to implement the features required by each version or release. Systems to facilitate this modification are desired.

### BRIEF DESCRIPTION OF THE DRAWINGS

FIG. 1 is a block diagram of a system architecture according to some embodiments.

FIG. 2 is a flow diagram according to some embodiments.

FIG. 3 is a representation of a user interface of a software development environment according to some embodiments.

FIG. 4 is a representation of a user interface of a software development environment according to some embodiments.

FIG. 5 is a representation of a user interface of a software development environment according to some embodiments.

FIG. 6 is a representation of a user interface of a software development environment according to some embodiments.

FIG. 7 is a block diagram of a system architecture according to some embodiments.

FIG. 8 is a flow diagram according to some embodiments.

FIG. 9 is a diagram illustrating a deployed system according to some embodiments.

FIG. 10 is a block diagram of a hardware system according to some embodiments.

### DETAILED DESCRIPTION

The following description is provided to enable any person in the art to make and use the described embodiments. Various modifications, however, will remain readily apparent to those in the art.

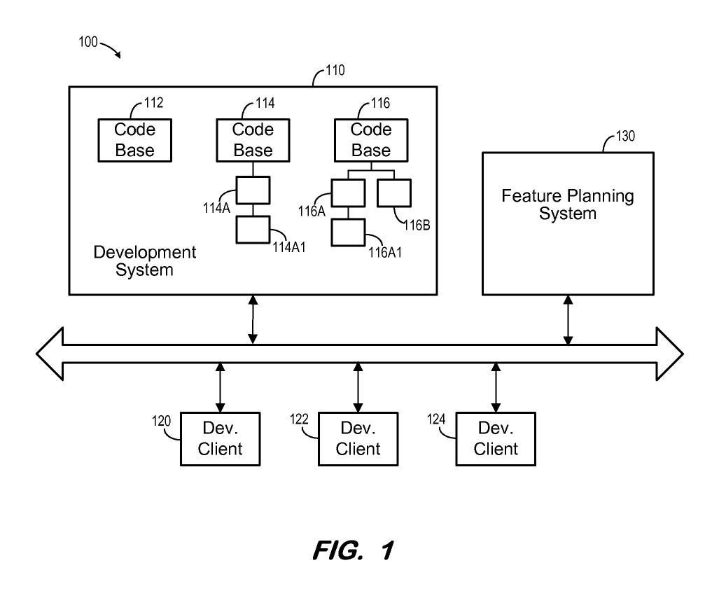

FIG. 1 is a block diagram of development system architecture 100. Architecture 100 includes development system 110, development client computing systems 120-124, and feature planning system 130. Embodiments are not limited to architecture 100.

Any of the depicted elements of architecture 100 may be implemented by one or more hardware devices coupled via any number of public and/or private networks. Two or more of such devices may be located remote from one another all devices may communicate with one another via any known manner of network(s) and/or via a dedicated connection.

Development client systems 120-124 may comprise a desktop computer, a laptop computer, a netbook computer, a tablet computer, a smartphone, and/or any other computing system that is or becomes known. Each of systems 120-124 provides a development environment for developing program code. For example, each of systems 120-124 may include a memory storing program code of an Integrated Development Environment and a processor to execute the code. The code of the Integrated Development Environment may be located remote from systems 120-124 and provided as a service, in which case systems 120-124 execute program code of a client application such as a Web browser.

Development system 110 stores program code of software applications. Development system 110 may also provide compilation functions and/or an Integrated Development Environment as described above according to some embodiments. Accordingly, development client systems 120-124 may utilize functionality provided by development system 110 to develop software applications.

Code bases 112, 114 and 116 represent the core code of respective software applications. Code bases 114 and 116 are associated with development branches. Specifically, code base 114 is associated with a development branch comprising program code 114A and 114A1, and code base 116 is associated with two development branches, one including program code 116A and 116A, and the other including program code 116B. According to some embodiments, one or more developers may create and modify program code stored in development system 110.

Feature planning system 130 may facilitate the planning and management of software application development. Feature planning system 130 may allow developers to create lists of application features, prioritize feature development, distribute the development of features to workgroups, assign features to various software releases, etc. Feature planning system 130 may comprise a computer server which executes program code of a feature planning software application. According to some embodiments, feature planning system 130 is an element of development system 110.

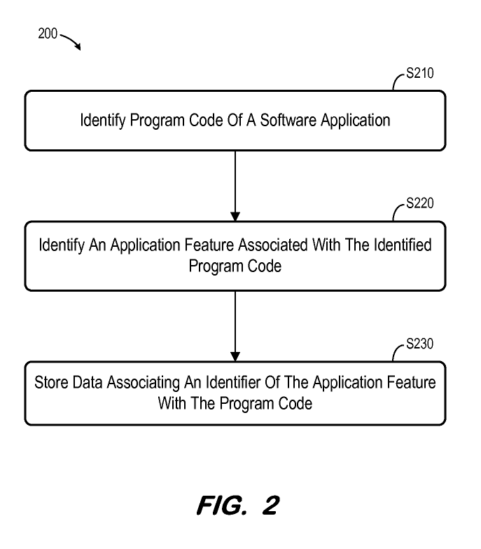

FIG. 2 is a flow diagram of process 200 according to some embodiments. Process 200 and each other process described herein may be embodied in processor-executable program code read from one or more non-transitory computer-readable media, such as a floppy disk, a CD-ROM, a DVD-ROM, a Flash drive, a fixed disk and a magnetic tape, and then stored in a compressed, uncompiled and/or encrypted format. Accordingly, a processor of any suitable device or devices may execute the program code to cause the device or devices to operate as described. In some embodiments, hard-wired circuitry may be used in place of, or in combination with, program code for implementation of processes according to some embodiments. Embodiments are therefore not limited to any specific combination of hardware and software.

Initially, at S210, program code of a software application is identified. Next, an application feature associated with the program code is identified at S220. According to some embodiments, the application feature is identified first, and associated program code of a software application is then identified. Examples reflecting both scenarios will be described below.

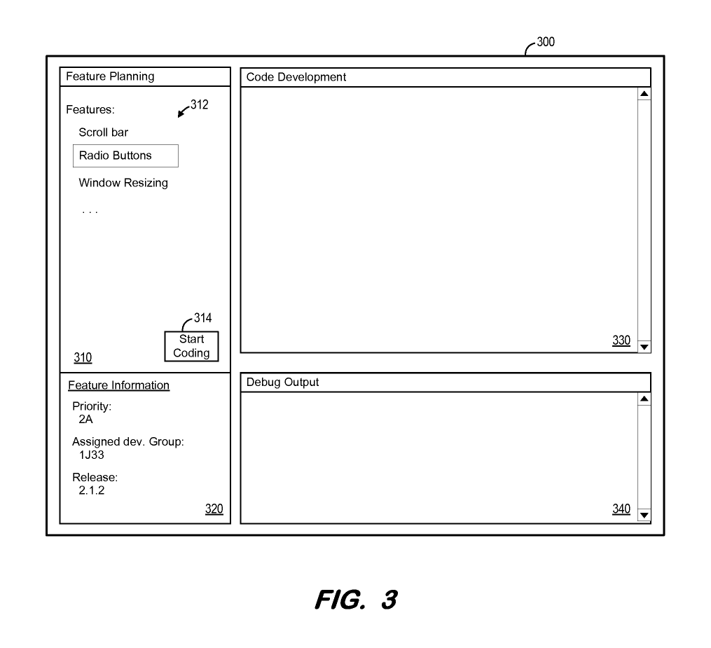

FIG. 3 is a view of user interface 300 of an integrated development environment according to some embodiments. User interface 300 may be presented to a software developer by one of development client systems 120-124. As mentioned above, the integrated development environment may be provided by software executed by the development client system and/or by software executed by development system 100.

User interface 300 includes feature area 310 and feature information area 320. Feature area 310 includes feature list 312 and control 314, and feature information area 320 displays information relating to a currently-selected feature of feature list 312 (e.g., Radio Buttons). The information displayed in areas 310 and 320 may be provided by feature planning system 130, but embodiments are not limited thereto.

A developer enters program code, in any suitable programming language, into code development area 330. Execution of such program code provides debug output which is displayed in debug output area 340. An integrated development environment according to some embodiments may provide additional controls and features not described herein.

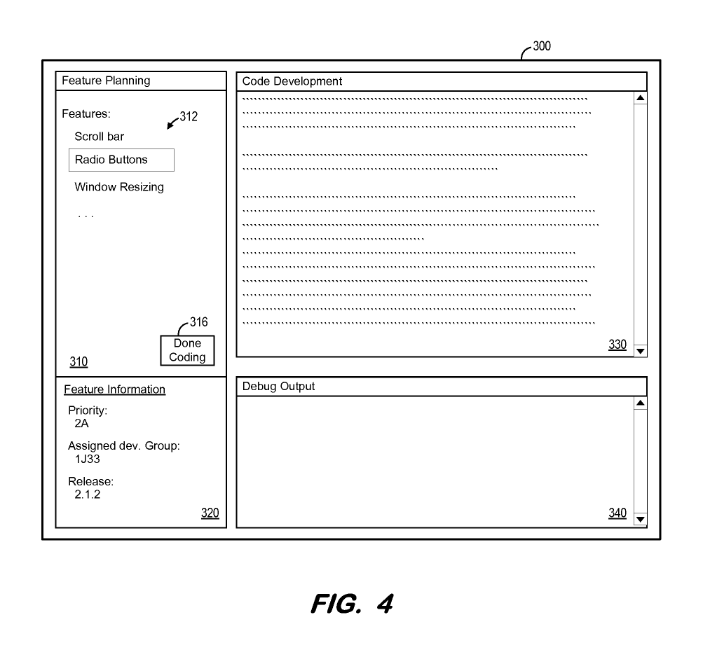

With respect to process 200, a developer may select a feature from feature list 312 and then select Start Coding control 314. Next, as illustrated in FIG. 4, the developer enters program code into code development area 330. Once the selected feature is implemented in program code, the developer selects the Done Coding control of feature area 310. As a result of these actions, the feature is associated with the entered program code. More generally, any modifications to program code which are performed between the two selections of control 316 are determined to be associated with the selected feature. These modifications may include one or more of addition of program code, deletion of program code, and/or editing of program code.

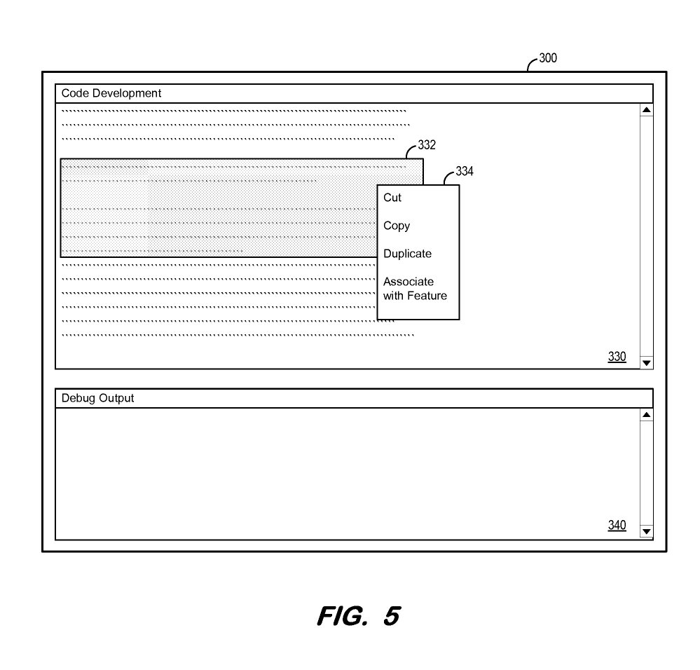

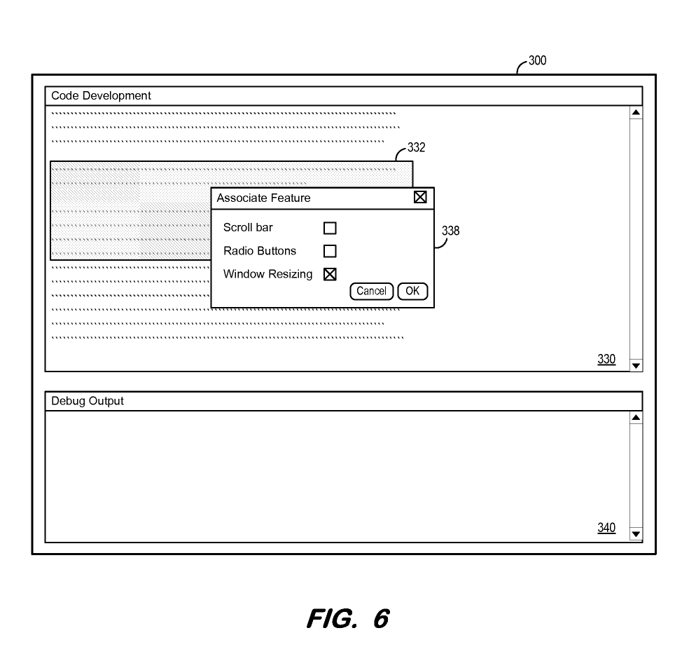

FIGS. 5 and 6 illustrate another paradigm for identifying program code and an associated application feature. As shown in FIG. 5, code development area 330 of user interface 300 displays program code of a software application. The developer has selected program code portion 332 (e.g., by operating a mouse to select a rectangular area of interface 300) and invoked context menu 334 (e.g., by “right-clicking” the selected area).

It will be assumed that the developer selects the Associate with Feature option of context menu 334. As a result, window 338 of FIG. 6 is displayed. Window 338 displays a list of features (e.g., provided by feature planning system 130) which may be associated with the selected program code. According to some embodiments, the developer may manually enter a feature name into window 338.

Embodiments are not limited to the examples of FIGS. 3-6. Embodiments may employ any system for identifying an association between program code and an application feature.

Returning to process 200, data associating the program code with an identifier of the application feature is stored at S230. The identifier of the feature may comprise a descriptive and/or technical name of the feature, an alphanumeric ID, or any other suitable identifier. The associated program code may comprise a text file including the program code (which, as described above, may include added and/or deleted program code). The data may be a database table record including fields identifying the feature and the program code. Such a record may include other fields, such as those identifying one or more developers of the program code, a date the feature was added, a software version associated with the feature, etc.

According to some embodiments, the stored data comprises parseable text inserted within the program code itself For example, a developer may place text markers around portions of program code and an identifier of an associated feature within one or more of the markers.

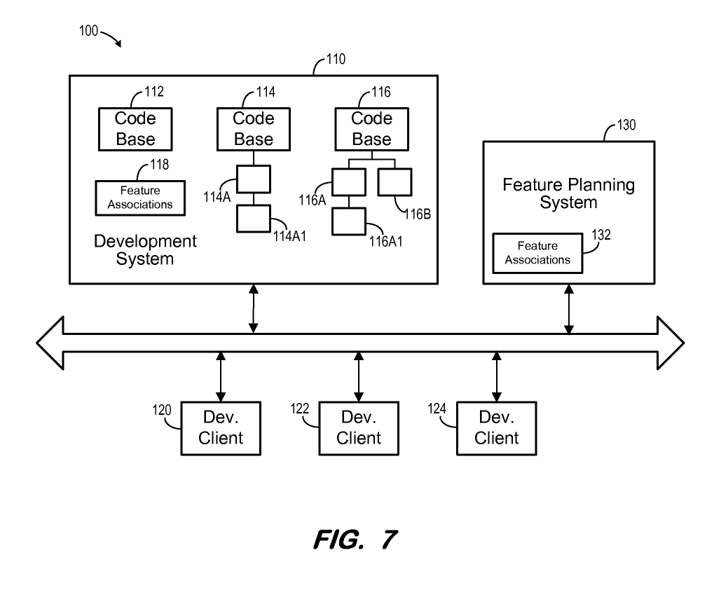

FIG. 7 illustrates system 100 including the data (i.e., “feature associations”) stored according to some embodiments of S230. Development system 110 stores feature associations 118 and feature planning system stores feature associations 132. FIG. 7 is intended to illustrate two possible storage locations for the feature associations, and not to indicate that feature associations need to be stored in two locations, or, if two or more storage locations are used, that the feature associations stored in each location be identical.

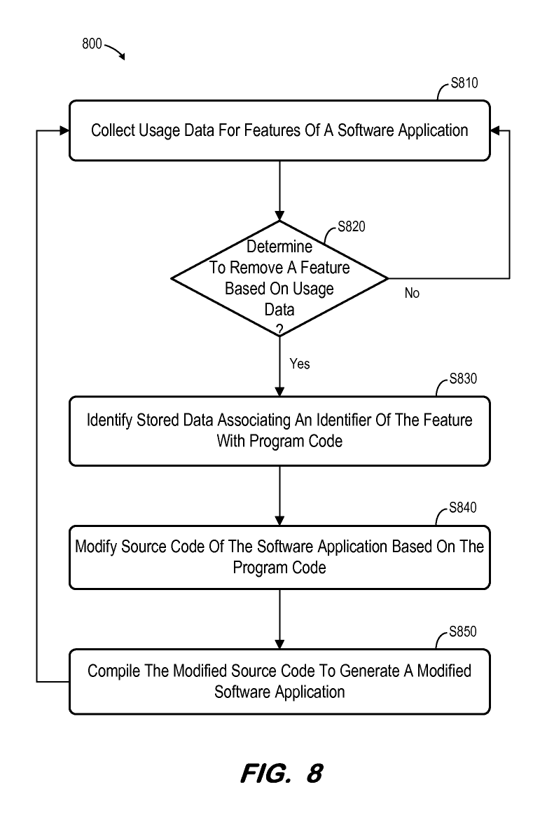

FIG. 8 is a flow diagram of process 800 to utilize the stored data of S230 in order to remove a feature of a software application according to some embodiments. It will be assumed that the software application is the executable result of compiling program code which was developed as described above.

Usage data for features of the software application are collected at S810. The usage data describes the quantity and quality of usage of particular features of the software application. Usage data may be collected for any number and type of application features. For example, the usage data may indicate how often a particular analysis function is used, how often a particular user interface is accessed, how often a user abandons a particular workflow, etc.

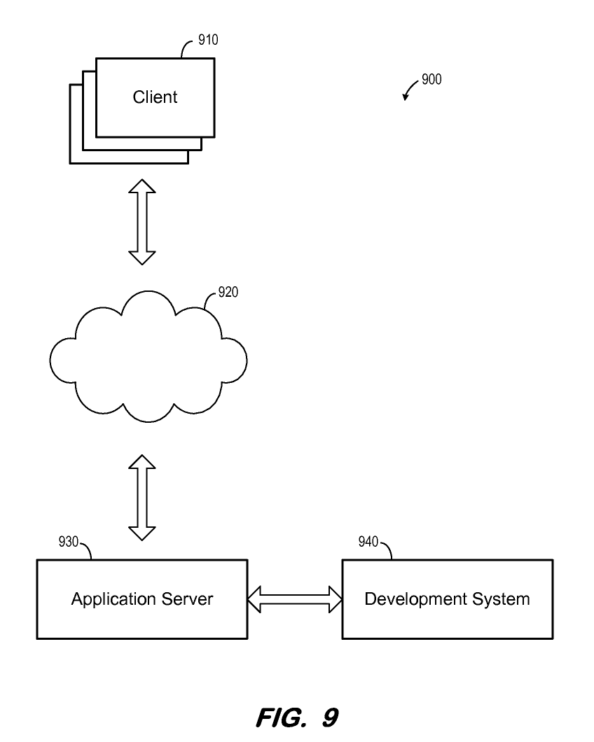

The usage data may be collected by the software application as the application executes on a client system and/or an application server. Collection of usage data of many users may be facilitated in a case that the application is served by an application server. In this regard, FIG. 9 illustrates system 900 according to some embodiments.

System 900 includes a plurality of clients 910. Each of clients 910 comprises a hardware device including a processor for executing a client application such as, but not limited to, a Web browser. Network 920 may comprise any number of electronic networks for transmitting data. In some embodiments, network 920 is the World Wide Web. According to the illustrated embodiment, application server 930 executes the software application, receives data from and transmits data to clients 910, and collects the usage data at S810.

Next, at S820, it is determined whether to remove a feature from the software application based on the usage data. The determination may occur at predetermined intervals, after collection of a particular amount of usage data, upon instruction of an administrator of application server 930, and/or continuously.

It may be determined at S820 to remove a feature for any reason. According to some embodiments, it may be determined to remove a feature if it is rarely used, if it is often used incorrectly, if it impacts performance significantly, if it results in an unacceptable frequency of crashes, etc. In some embodiments, the determination at S820 may be user-specific. That is, it may be determined at S820 to remove a feature from the software application for a particular user or subset of users (e.g., employees of a particular company).

Flow cycles between S810 and S820 to continue to collect usage data until the determination at S820 is affirmative. At this point, flow proceeds to S830 to identify stored data which associates an identifier of the feature with program code. As described above, such data may be stored in development system 940. Accordingly, application server 930 may operate in conjunction with development server 940 at S830 to identify stored data of development system 940 which associates an identifier of the feature with program code. The data may comprise the source code of the software application (e.g., in a case that the feature identifier is embedded in the source code), a database table record, or any other suitable data structure. The program code associated with the identifier may include program code which was added to implement the feature, was deleted to implement the feature, and/or was edited to implement the feature.

Next, at S840, source code of the software application is modified based on the program code. Modification may be performed by development system 940 according to some embodiments. Modification of the source code may include automatic deletion from the source code of program code which was added to implement the feature, automatic addition from the source code of program code which was deleted to implement the feature, and/or automatic reversal of edits made to program code of the source code to implement the feature.

The modified source code is compiled at S850 to generate a modified software application. The modified software application may then be deployed to one or more clients using any suitable deployment paradigm. According to some embodiments, the modified software application is deployed by development system 940 to application server 930, and served to one or more clients 910 therefrom.

Flow returns from S850 to S810 to continue collection of usage data. In this regard, it may be subsequently determined at S820 to remove a second feature from the modified software application, in which case flow proceeds as described above to identify stored data associating an identifier of the second feature with second program code, to modify the source code of the modified software application based on the second program code, and to compile the modified source code of the modified software application to generate a second modified software application.

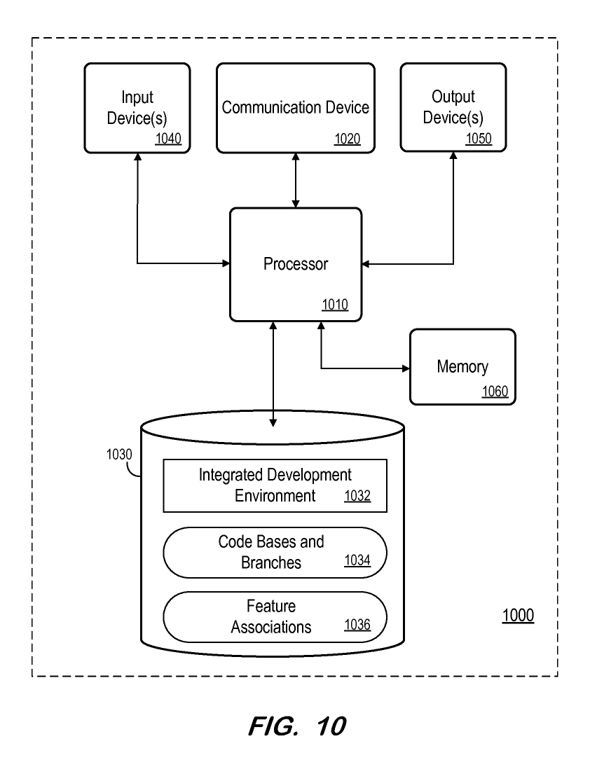

FIG. 10 is a block diagram of apparatus 1000 according to some embodiments. Apparatus 1000 illustrates a hardware architecture implementing a development system as described above, but implementations are not limited thereto. Elements of apparatus 1000 may therefore operate to execute methods as described above. Apparatus 1000 may include other unshown elements according to some embodiments.

Apparatus 1000 includes processor 1010 operatively coupled to communication device 1020, data storage device 1030, one or more input devices 1040, one or more output devices 1050 and memory 1060. Communication device 1020 may facilitate communication with external computing systems, such as via a computer network. Input device(s) 1040 may comprise, for example, a keyboard, a keypad, a mouse or other pointing device, a microphone, knob or a switch, an infra-red (IR) port, a docking station, and/or a touch screen. Input device(s) 1040 may be used, for example, to enter information into apparatus 1000. Output device(s) 1050 may comprise, for example, a display (e.g., a display screen) a speaker, and/or a printer.

Data storage device 1030 may comprise any appropriate persistent non-transitory storage media, including combinations of magnetic storage devices (e.g., magnetic tape, hard disk drives and flash memory), optical storage devices, Read Only Memory (ROM) devices, etc., while memory 1060 may comprise Random Access Memory (RAM).

Integrated development environment 1032 of data storage device 1030 may comprise program code executable by processor 1010 to provide any of the functions described herein, including but not limited to processes 200 and 800. Embodiments are not limited to execution of these functions by a single apparatus. Data storage device 1030 may also store data and other program code for providing additional functionality and/or which are necessary for operation thereof, such as device drivers, operating system files, etc.

Code bases and branches 1034 may include source code of one or more software applications. The source code may also include data associating features of the software applications with program code. Moreover, feature associations 1036 may also or alternatively include data associating features of the software applications with program code.

All systems and processes discussed herein may be embodied in program code stored on one or more computer-readable non-transitory media. Such non-transitory media may include, for example, a fixed disk,a floppy disk, a CD-ROM, a DVD-ROM, a Flash drive, magnetic tape, and solid state RAM or ROM storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a processor; and
a memory storing processor-executable process steps executable by the processor to cause the system to:
determine a feature of a software application to be removed from the software application;
identify stored data associating an identifier of the feature with first program code;
modify source code of the software application based on the first program code; and
compile the modified source code to generate a modified software application.

2. A system according to claim 1, the process steps further executable by the processor to cause the system to:
collect usage data for each of a plurality of features of the software application,
wherein determination of the feature comprises determination of the feature from the plurality of features based on the usage data.

3. A system according to claim 1, wherein modification of the source code comprises removal of the first program code from the source code.

4. A system according to claim 1, wherein modification of the source code comprises removal of a first portion of the first program code from the source code and addition of a second portion of the first program code to the source code.

5. A system according to claim 1, the process steps further executable by the processor to cause the system to:
determine a second feature of a software application to be removed from the software application;
identify second stored data associating a second identifier of the second feature with second program code;
modify the modified source code of the software application based on the second program code; and
compile the modified modified source code to generate a second modified software application.

6. A system according to claim 5, wherein modification of the source code comprises removal of a first portion of the first program code from the source code and addition of a second portion of the first program code to the source code, and
wherein modification of the source code comprises removal of the first program code from the source code.

7. A method implemented by a computing system in response to execution of program code by a processor of the computing system, the method comprising:
determining a feature of a software application to be removed from the software application;
identifying stored data associating an identifier of the feature with first program code;
modifying source code of the software application based on the first program code; and
compiling the modified source code to generate a modified software application.

8. A method according to claim 7, further comprising:
collecting usage data for each of a plurality of features of the software application,
wherein determining the feature comprises determining the feature from the plurality of features based on the usage data.

9. A method according to claim 7, wherein modifying the source code comprises removing the first program code from the source code.

10. A method according to claim 7, wherein modifying the source code comprises removing a first portion of the first program code from the source code and adding a second portion of the first program code to the source code.

11. A method according to claim 7, further comprising:
determining a second feature of a software application to be removed from the software application;
identifying second stored data associating a second identifier of the second feature with second program code;
modifying the modified source code of the software application based on the second program code; and
compiling the modified modified source code to generate a second modified software application.

12. A method according to claim 11, wherein modifying the source code comprises removing a first portion of the first program code from the source code and adding a second portion of the first program code to the source code, and
wherein modifying the source code comprises removing the first program code from the source code.

13. A computer-readable medium storing processor-executable process steps, the process steps executable by a processor to cause a computing device to:
determine a feature of a software application to be removed from the software application;
identify stored data associating an identifier of the feature with first program code;
modify source code of the software application based on the first program code; and
compile the modified source code to generate a modified software application.

14. A medium according to claim 13, the process steps further executable by a processor to cause a computing device to:
collect usage data for each of a plurality of features of the software application,
wherein determination of the feature comprises determination of the feature from the plurality of features based on the usage data.

15. A medium according to claim 13, wherein modification of the source code comprises removal of the first program code from the source code.

16. A medium according to claim 13, wherein modification of the source code comprises removal of a first portion of the first program code from the source code and addition of a second portion of the first program code to the source code.

17. A medium according to claim 13, the process steps further executable by a processor to cause a computing device to:
determine a second feature of a software application to be removed from the software application;
identify second stored data associating a second identifier of the second feature with second program code;
modify the modified source code of the software application based on the second program code; and
compile the modified modified source code to generate a second modified software application.

18. A medium according to claim 17, wherein modification of the source code comprises removal of a first portion of the first program code from the source code and addition of a second portion of the first program code to the source code, and
wherein modification of the source code comprises removal of the first program code from the source code.
